(19) United States
(12) Patent Application Publication
(10) Pub. No.: US 2014/0188313 A1
(43) Pub. Date: Jul. 3, 2014

(54) Adaptive control method for air conditioning system of an electric car

(71) Applicant: Xiaofeng Huang, Changzhou (CN)

(72) Inventor: Xiaofeng Huang, Changzhou (CN)

(73) Assignee: Westernhouse Automation (Changzhou) Co., Ltd., Changzhou, Jiangsu (CN)

(21) Appl. No.: 13/820,523

(22) PCT Filed: Aug. 21, 2012
(86) PCT No.: PCT/CN12/80416

§ 371 Date: Mar. 4, 2013

(30) Foreign Application Priority Data
Aug. 24, 2011 (CN) 201110250316.2

(51) Int. Cl. B60H 1/00

(52) U.S. Cl. CPC B60H 1/00735
USPC 701/22

(57) ABSTRACT

An adaptive control method for air conditioning system of an electric car includes the steps of (1) instructing a vehicle monitoring system (VMS) to check operating parameters of the electric car; (2) instructing the VMS to send maximum power (PACe) of the air conditioning system to an air conditioning system controller (ASC); (3) instructing the ASC to check the operating parameters of the electric car in order to determine whether the air conditioning system should be opened; (4) closing the air conditioning system if the determination of step (3) is negative or comparing the PACe of the air conditioning system with threshold power (PACt) of the air conditioning system if the determination of step (3) is positive; and (5) closing or operating the air conditioning system based on result of the comparison of step (4).

### BACKGROUND OF THE INVENTION

1. Field of the Invention

The invention relates to electric cars and more particularly to an adaptive control method for air conditioning system of an electric car.

2. Description of Related Art

Air conditioning system is basic for modern automobiles and is essential to the manufacturing of automobiles. Air conditioning system for an internal combustion engine (ICE) propelled automobile typically comprises condenser coils, an expansion valve, evaporator coils, a compressor, and a control device. The compressor is opened by the engine and an electromagnetic clutch or an independent ICE. The air conditioning system is propelled by the ICE and temperature control is essential to the air conditioning system.

Air conditioning system for an electric car typically comprises condenser coils, an expansion valve, evaporator coils, a compressor, and a control device. However, opening and control of the air conditioning system for an electric car are different from that of an ICE propelled car. There is a type (i.e., the first scheme) of air conditioning system for electric car powered by an independent ICE to activate the compressor. This is similar to the typical air conditioning system powered by an independent ICE. The automobile is additionally equipped with an ICE so it is not a true electric car. There is another type (i.e., the second scheme) of air conditioning system for electric car wherein the car's electric system supplies power to an electric motor which in turn drives the open type or semi-closed type compressor. This is similar to replacing the ICE of an independent air conditioning system for automobile with an electric motor. There is still another type (i.e., the third scheme) of air conditioning system for electric car wherein the compressor is powered by an electric motor in cooperation with an electromagnetic clutch. This is similar to replacing the ICE for non-independent air conditioning system of ICE propelled automobile with an electric motor of an electric car. A further type (i.e., the fourth scheme) of air conditioning system for electric car is configured to have an electric motor in a compressor so that electricity can be supplied from the electric car to the air conditioning system for opening. This is similar to air conditioner installed in a house. Drawbacks including low thermal conversion efficiency due to belt or gear arrangement between the electric motor and the compressor are found in the typical air conditioning system for ICE propelled cars and above first to third schemes when energy conversion efficiency and transmission are under consideration. The fourth scheme is high energy conversion efficiency and low in transmission loss. Specifically, the fourth scheme is applicable to variable speed compressors so as to further increase efficiencies of both the compressor and the air conditioning system.

Regarding air conditioning system for automobile, rotating speed of the motor for an independent air conditioning system is stable and input power is stable in normal operation. Compressor of a non-independent air conditioning system is connected to a drive shaft of a motor via a belt. Rotating speed of a compressor changes as that of the engine changes. Typically, rotating speed ratio of the compressor to the engine is about 1:1-1.2. A driver may change the rotating speed of the engine when driving. For example, rotating speed of the compressor increases as that of the engine increases when greater power is required. Also, input power of the air conditioning system is increased. But this does not means input power of the air conditioning system should be increased for generating more cooled air. To the contrary, increases of cooling power and input power of the air conditioning system are due to increase of the rotating speed of the compressor. That is, power more than required is consumed by the air conditioning system due to undesired design of the air conditioning system. And in turn, it consumes more energy. This is why many small cars do not have enough power to keep normal driving speed after the air conditioning system is opened. Thus, the design of increasing input power of the air conditioning system when engine output power increases is undesired.

Regarding electric cars, both engine's output power and input power of air conditioning system are supplied by electric system of the electric car which is limited in general. More input power of the air conditioning system means less power output to drive the car. And in turn, it may limits the maximum driving range per charge. This is clear that engine of an automobile plays a more important role than air conditioning system thereof. For providing sufficient power to move the automobile when driving to keep the maximum driving range per charge so as to determine whether the air conditioning system should be opened, it is desirable of measuring the remaining power of the electric system, checking the maximum discharge coefficient and other parameters. The air conditioning system should be closed if power supply from the engine to power the automobile is no sufficient. China Patent No. CN101623998A, entitled “air conditioning system for electric car and control method thereof” and China Patent No. CN101852476A, entitled “air conditioning system for electric car and method for controlling same” both disclose similar schemes. In short, it takes air conditioning system as an auxiliary system which can be loaded or unloaded depending on engine's output power. Thus, sufficient power can be supplied to the automobile while driving. However, a frequent loading or unloading of the air conditioning system may cause discomfort to occupants. Further, it may consume more energy due to higher starting torque. To the worse, it may adversely affect the reliability and useful life of both the compressor and the air conditioning system.

China Patent No. CN101913314A, entitled “air conditioning system for electric car and method for controlling same”, discloses the following: Both compressor and blower rotate in higher speed when higher heat-extraction capacity of refrigeration and air conditioning of the air conditioning system is required. To the contrary, both compressor and blower rotate in lower speed when lower heat-extraction capacity of refrigeration and air conditioning of the air conditioning system is required. This has the benefit of saving energy. The patent discloses that “adjusting rotating speed of the engine based on heat-extraction capacity of refrigeration and air conditioning of the air conditioning system for decreasing power consumption and saving energy.” However, neither method of checking or measuring heat-extraction capacity of refrigeration and air conditioning of the air conditioning system nor method of regulating the rotating speed of the engine is disclosed by the patent. Further, power supplied to the automobile for driving is more important than supplied to the air conditioning system even when heat-extraction capacity of refrigeration and air conditioning of the air conditioning system is dynamically adjusted for saving energy by regulating the rotating speed of the engine. In short, the air conditioning system should be closed immediately when electric power supplied to the automobile for driving is insufficient.

In view of above, both fossil fuel powered vehicles and electric cars take air conditioning system as an auxiliary system. Power consumption of drive system and air conditioning system of the automobiles is not properly considered. This unfortunately makes an optimum design of automobiles impossible.

Typically, characteristic time (or response time) of the drive system of an automobile is shorter and characteristic time (or response time) of the air conditioning system thereof is longer. That is, drive system of an automobile may increase, decrease output power, or even stop power output when driving due to acceleration, de-acceleration, gear shift, or braking. This is done in a few seconds or even simultaneously. But operation of the air conditioning system of the automobile is different from that of the drive system thereof. A temperature set point in an automobile can be reached after tens seconds or even several minutes after opening the air conditioning system. Further, it takes more time for occupants in the automobile feeling a degree of comfort due to temperature drop. Furthermore, input power and corresponding heat-extraction capacity of refrigeration and air conditioning of the air conditioning system may temporarily vary when the air conditioning system is opening. This in turn may prolong time needed for occupants in the automobile feeling a degree of comfort due to temperature drop. Thus, it is desirable of optimizing energy consumption of both the drive system and the air conditioning system of an automobile so that input power of the air conditioning system can be controlled based on power consumption of the drive system. Response time of the drive system is greatly different from that of the air conditioning system. Thus, it is possible of supplying sufficient power to the drive system without increasing total power consumption. This has the benefit of minimizing temperature change in a car. Further, occupants may not feel any temperature change or a sudden increase of temperature in the car. As a result, both drive system and air conditioning system of an automobile can be optimized.

### SUMMARY OF THE INVENTION

It is therefore one object of the invention to provide an adaptive control method for air conditioning system of an electric car by considering characteristics of electrical system, drive system, and air conditioning system of the electric car. Advantages including optimizing the air conditioning system, increasing reliability of the air conditioning system, decreasing energy consumption of the air conditioning system, and increasing performance of the electric car are obtained while maintaining sufficient power output to the drive system of the electric car.

In one aspect of the invention there is provided an adaptive control method for an air conditioning system of an electric car comprising the steps of (1) instructing a vehicle monitoring system (VMS) to check operating parameters of the electric car; (2) instructing the VMS to send maximum power (PACe) of the air conditioning system to an air conditioning system controller (ASC); (3) instructing the ASC to check the operating parameters of the electric car in order to determine whether the air conditioning system should be opened or not; (4) closing the air conditioning system if the determination of step (3) is negative or comparing the PACe of the air conditioning system with threshold power (PACt) of the air conditioning system if the determination of step (3) is positive; and (5) (a) closing the air conditioning system if PACe<PACt is a result of the comparison of step (4); (b) operating the air conditioning system in conditions set by the PACt if PACe=PACt is the result of the comparison of step (4), or (c) operating the air conditioning system in conditions set by the ASC if PACe>PACt.

Preferably, VMS and ASC of the invention are modules capable of controlling themselves, two independent systems or two software modules of a hardware system.

Preferably, step (1) of instructing VMS to check operating parameters of a running automobile is done by regularly scanning, and step (2) of instructing VMS to send PACe of the air conditioning system to ASC is done by interrupting requests.

Preferably, parameters of step (1) of instructing VMS to check operating parameters of a running automobile represent battery connection of the electrical system, and/or charging status of the battery, and/or the maximum allowable discharge power Pa of the battery, operating power Pe of the drive system, and operating power Ps of other systems.

Preferably, in step (2) the PACe is no greater than a subtraction of the Pe of the drive system and the Ps of other systems from the Pa as expressed by PACe≦Pa−Pe−Ps.

Preferably, sub-step (c) of step (5) comprises at least one of (I) In response to changing a stop status to an activation status of the air conditioning system, the air conditioning system operating a predetermined period of time is based on operating conditions corresponding to the PACt; (II) in response to starting the electric car and requesting turning on the air conditioning system, gradually increasing an input power (PAC) of the air conditioning system until the PAC reaches a maximum operating power (PACh) of the air conditioning system but no greater than the PACe of the air conditioning system; (III) adjusting the PAC of the air conditioning system in response to a temperature difference (dT) between temperature inside the electric car and a temperature set point; and (IV) closing the air conditioning system if the dT is less than a set threshold of the temperature difference (dTs).

Preferably, is between 1 to 30 seconds.

Preferably, dTs is between 0.5 to 3° C.

In the method of adjusting input power of the air conditioning system the compressor of the air conditioning system is a compressor capable of adjusting an output which means input power of the air conditioning system can be adjusted. Specifically, the compressor capable of adjusting an output is a speed adjustable compressor. The rotating speed of the compressor is adjusted by using an inverter or a predetermined regulator so as to adjust an output of the compressor, and also an output power of the air conditioning system. Another type of compressor capable of adjusting an output is a volume adjustable compressor such as a compressor having an unloading device or a digital vortex compressor. An adjustment of a load adjusts both an output of the compressor and an output power of the air conditioning system.

In the method of adjusting input power of the air conditioning system fan motors of both the condensing coil and the evaporator coil of the air conditioning system are speed adjustable motors. Rotating speed of the motor can be adjusted by using an inverter or the motor has a plurality of speeds for adjustment so as to adjust the input power of the air conditioning system.

In the method of adjusting input power of the air conditioning system the regulation device of the air conditioning system to be an electronic expansion valve. It is possible of adjusting pressure drop of the air conditioning system by controlling openness of the electronic expansion valve. As a result, input power of the air conditioning system can be adjusted.

In step (III) the adjustment comprises at least one of conditions of (1) configuring a compressor of the air conditioning system to have at least three adjustable rotating speeds, and a fan motor of the air conditioning system to have at least two adjustable rotating speeds; (2) decreasing a rotating speed of the compressor, and decreasing rotating speeds of fan motors of both a condensing coil and an evaporator coil of the air conditioning system if dT<dTs with an operating power of the air conditioning system being not greater than the PACe otherwise the air conditioning system be closed; (3) operating the compressor in an intermediate speed, and increasing the rotating speeds of the fan motors of both the condensing coil and the evaporator coil if dT>dTs and dT<T1 with the operating power of the air conditioning system being not greater than the PACe otherwise condition (2) be applied; and (4) increasing the rotating speed of the compressor, and increasing the rotating speeds of the fan motors of both the condensing coil and the evaporator coil if dT>T1 with the operating power of the air conditioning system being not greater than the PACe otherwise condition (3) be applied.

Preferably, dTs is between 0.5 to 3° C. and T1 is between 5 to 10° C.

Preferably, conditions corresponding to the PACt of the air conditioning system comprise at least one of conditions of (1) opening a variable speed compressor to operate in a minimum rotating speed, or opening a power adjustable compressor to operate in a minimum load; (2) opening the fan motors of both the condensing coil and the evaporator coil to operate in a minimum speed; and (3) opening an electronic expansion valve to a maximum openness.

By utilizing the invention, the following advantages can be obtained: The adaptive control method for air conditioning system of an electric car can match the input power of the air conditioning system to energy consumed by the drive system so that a sufficient power is supplied to the electric car for driving, performance of the air conditioning system is increased greatly, temperature inside the electric car can be precisely controlled, a degree of comfort can be brought to occupants, and a maximum driving range per charge of the electric car can be obtained.

The above and other objects, features and advantages of the invention will become apparent from the following detailed description taken with the accompanying drawings.

### BRIEF DESCRIPTION OF THE DRAWINGS

FIG. 1 is a diagram of a control system of an electric car according to the invention;

FIG. 2A is a chart showing temperature versus time for Tcar a conventional air conditioning system of an electric car;

FIG. 2B is a chart showing power versus time for Pac of the conventional air conditioning system of the electric car;

FIG. 2C is a chart showing power versus time for Pmt of the conventional air conditioning system of the electric car;

FIG. 3A is a chart showing temperature versus time for Tcar of an air conditioning system of an electric car according to the invention;

FIG. 3B is a chart showing power versus time for Pac of the air conditioning system of the electric car according to the invention; and

FIG. 3C is a chart showing power versus time for Pmt of the air conditioning system of the electric car according to the invention.

### DETAILED DESCRIPTION OF THE INVENTION

The invention is an adaptive control method for air conditioning system of an electric car. The following description is directed to a preferred embodiment of the invention.

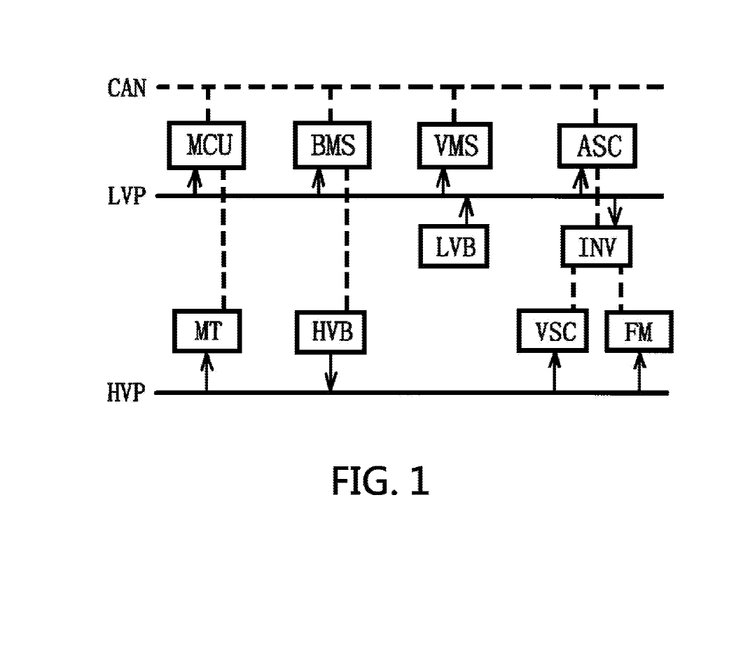

Referring to FIG. 1, a diagram of control system of the electric car of the invention is shown. It is noted that systems not essential to the invention are removed for the sake of brevity. Dotted lines represent communication or control signals connections and lines represent power connections. For the electric car, VMS is an acronym of vehicle monitoring system, MCU is an acronym of motor control unit, BMS is an acronym of battery monitoring system, ASC is an acronym of air conditioning system controller, MT is an acronym of motor, HVB is an acronym of high voltage battery, LVB is an acronym of low voltage battery, INV is an acronym of inverter, VSC is an acronym of variable speed compressor, FM is an acronym of fan motor, CAN is an acronym of campus area network, LVP is an acronym of low voltage power, and HVP is an acronym of high voltage power. VMS, MCU, BMS, and ASC of the electric car are connected to CAN. LVB supplies low voltage power to VMS, MCU, BMS, ASC, and INV via LVP. HVB supplies high voltage power to MT, VSC, and FM via HVP.

In the embodiment, VMS and ASC are modules capable of controlling themselves. They can be two independent systems or two software modules of a hardware system.

VSC is a compressor with rotating speed adjustment capability. For example, multiple speed adjustment is provided. INV can adjust the rotating speed of the compressor so as to adjust output power of the compressor and input power of the air conditioning system.

The adaptive control method for air conditioning system of an electric car in accordance with the invention comprises the following steps:

(1) instructing VMS to check operating parameters of a running automobile;

(2) instructing VMS to send maximum power (PACe) of the air conditioning system to ASC;

(3) instructing ASC to check the operating parameters of the running automobile in order to determine whether the air conditioning system should be opened;

(4) closing the air conditioning system if the determination of step (3) is negative or instructing ASC to compare the PACe of the air conditioning system with the threshold power (PACt) of the air conditioning system if the determination of step (3) is positive; and

(5) closing the air conditioning system if PACe<PACt is a result of the comparison of step (4), operating the air conditioning system in conditions set by PACt if PACe=PACt is the result of the comparison of step (4), or operating the air conditioning system in conditions set by ASC if PACe>PACt.

Preferably, step (1) of instructing VMS to check operating parameters of a running automobile is done by regularly scanning, and step (2) of instructing VMS to send PACe of the air conditioning system to ASC is done by interrupting requests.

Preferably, parameters of step (1) of instructing VMS to check operating parameters of a running automobile represent battery connection of the electrical system, and/or charging status of the battery, and/or the maximum allowable discharge power Pa of the battery, operating power Pe of the drive system, and operating power Ps of other systems wherein operating power Ps of other system means operating power of high voltage power loads other than motor and air conditioning systems. The maximum allowable discharge power Pa, operating power Pe of the drive system, and operating power Ps of other systems are transmitted by direct monitoring power signals. Alternatively, they are power values obtained by transmitting signals representing monitoring current, rotating speed, etc. representing power and calculating same.

Preferably, PACe in step (2) of instructing VMS to send maximum power (PACe) of the air conditioning system to ASC is no greater than a subtraction of operating power Pe of the drive system and operating power Ps of other systems from maximum allowable discharge power Pa. That is, PACe≦Pa−Pe−Ps.

Preferably, in step (3) of instructing ASC to check the operating parameters of the running automobile in order to determine whether the air conditioning system should be opened the parameters represent temperature inside the automobile, and/or temperature outside the automobile, and/or temperature set point of the air conditioning system, and/or whether there is requesting turning on the air conditioning system.

Preferably, in step (5) of operating the air conditioning system in conditions set by ASC if PACe>PACt the conditions set by ASC include at least one of the following:

(1) In response to changing stop status to activation status of the air conditioning system, the air conditioning system operates a predetermined period of time ts based on operating conditions corresponding to PACt in order to decrease starting load of the compressor. Preferably, the predetermined period of time ts is between 1 to 30 seconds;

(2) in response to starting the engine of the automobile and requesting turning on the air conditioning system, gradually increases the input power PAC of the air conditioning system until the input power PAC reaches the maximum operating power PACh of the air conditioning system but no greater than PACe of the air conditioning system in order to increase the heat-extraction capacity of refrigeration and air conditioning of the air conditioning system so that temperature inside the automobile can be quickly dropped to the temperature set point;

(3) adjusting input power PAC of the air conditioning system in response to a temperature difference dT between temperature inside the automobile and the temperature set point wherein input power PAC of the air conditioning system is increased when temperature difference dT increases, and input power PAC of the air conditioning system is decreased when temperature difference dT decreases; and

(4) closing the air conditioning system if the temperature difference dT between temperature inside the automobile and the temperature set point is less than a set threshold of the temperature difference dTs, or opening the air conditioning system in conditions corresponding to the threshold power (PACt) of the air conditioning system. Preferably, dTs is between 0.5-3° C.

In above condition (1) of in response to changing stop status to activation status of the air conditioning system, the activation status includes starting the engine of the automobile and requesting turning on the air conditioning system, and requesting turning on the air conditioning system while the automobile is running.

In above condition (2) of starting the engine of the automobile and requesting turning on the air conditioning system, requesting turning on the air conditioning system while the automobile is running is not included. It is understood that temperature inside an automobile is either high or low immediately after starting the engine of the automobile. Thus, the air conditioning system is required to quickly activate the air conditioning system to its full capacity so that temperature inside the automobile can be quickly decreased.

The method of adjusting input power of the air conditioning system further comprises configuring the fan motor FM of the air conditioning system to be a speed adjustable motor. For example, the fan motor FM has at least two adjustable rotating speeds.

The method of adjusting input power of the air conditioning system further comprises configuring the regulation device of the air conditioning system to be an electronic expansion valve. It is possible of adjusting pressure drop of the air conditioning system by controlling openness of the electronic expansion valve. As a result, input power of the air conditioning system can be adjusted.

In above condition (3), the adjustment comprises at least one of the following:

(1) configuring the compressor to have at least three adjustable rotating speeds, and the fan motor FM to have at least two adjustable rotating speeds;

(2) opening the air conditioning system in conditions corresponding to the threshold power (PACt) of the air conditioning system, and opening INV to decrease the rotating speed of the compressor to a low speed, and increase the fan motors FMs of the condensing coil and the evaporator coil to a low speed if the temperature difference dT between temperature inside the automobile and the temperature set point is less than the set threshold of the temperature difference dTs (i.e., dT<dTs); (but operating power of the air conditioning system should not be greater than PACe. Otherwise, the air conditioning system may deactivate.)

(3) opening the air conditioning system in conditions corresponding to an intermediate speed, and opening INV to adjust the rotating speed of the compressor to an intermediate speed, and increase the fan motors FMs of the condensing coil and the evaporator coil to a high speed if the temperature difference dT between temperature inside the automobile and the temperature set point is greater than the set threshold of the temperature difference dTs (i.e., dT>dTs and dT<T1); (but operating power of the air conditioning system should not be greater than PACe. Otherwise, above condition (2) should be applied.) and

(4) opening the air conditioning system in conditions corresponding to a maximum power PACh, and opening INV to increase the rotating speed of the compressor to a high speed, and increase the fan motors FMs of the condensing coil and the evaporator coil to a high speed if the temperature difference dT between temperature inside the automobile and the temperature set point is greater than T1 (i.e., dT>T1); (but operating power of the air conditioning system should not be greater than PACe. Otherwise, above condition (3) should be applied.)

Preferably, dTs is between 0.5 to 3° C. and T1 is between 5 to 10° C.

Conditions corresponding to the threshold power (PACt) of the air conditioning system comprise at least one of the following:

(1) opening variable speed compressor to operate in a minimum rotating speed, or opening a power adjustable compressor to operate in a condition of minimum load;

(2) opening the fan motors FMs of the condensing coil and the evaporator coil to operate in a minimum speed; and

(3) opening the electronic expansion valve to a maximum openness.

The threshold power (PACt) of the air conditioning system means that the air conditioning system operates in a minimum power if operating power corresponding to PACt varies as temperature outside the automobile varies.

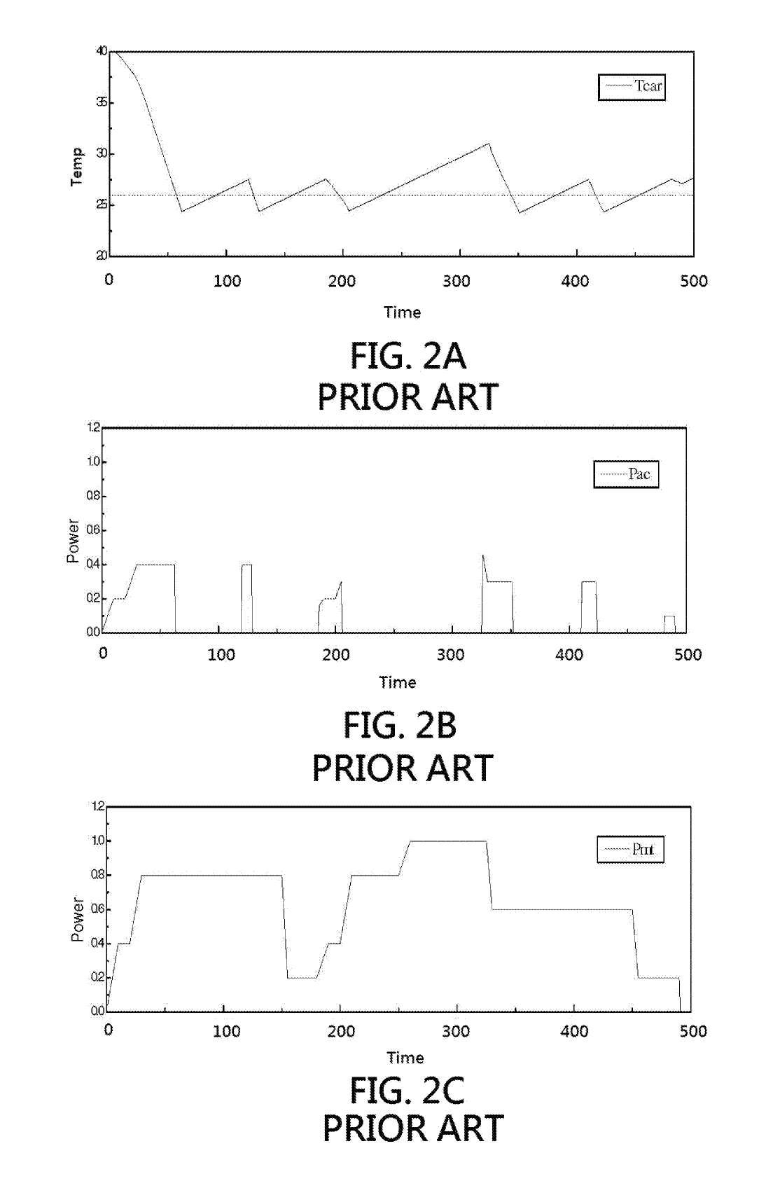

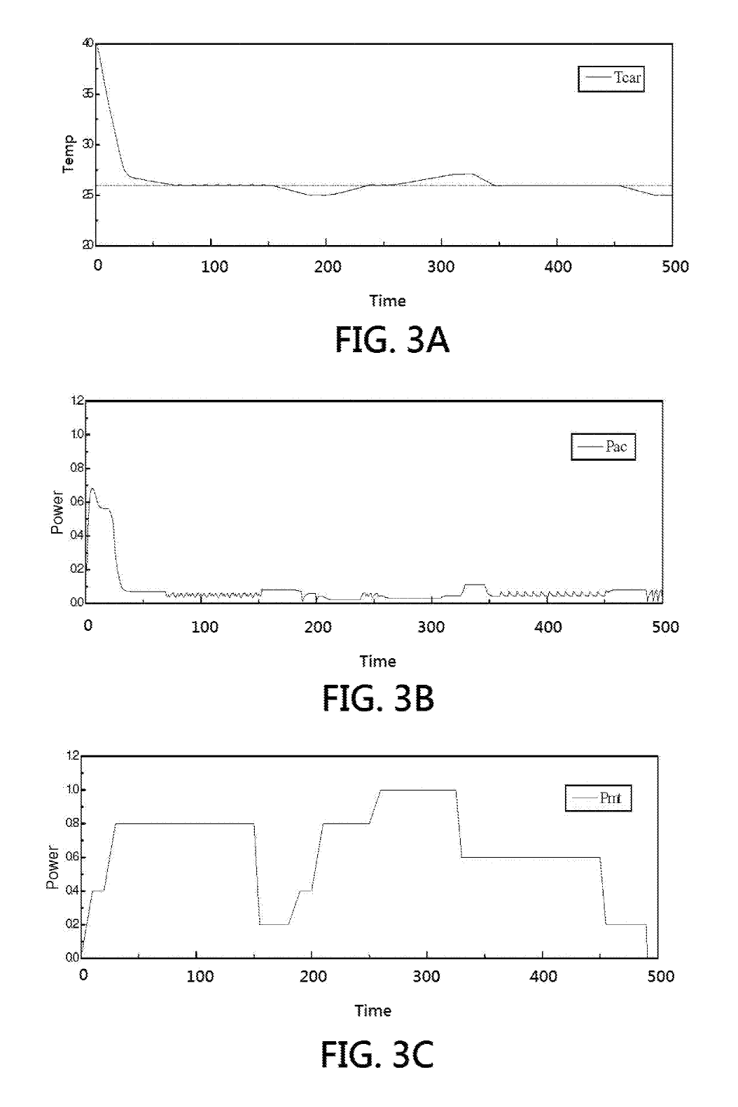

FIGS. 2A, 2B, and 2C are charts showing data of a conventional air conditioning system of an electric car and FIGS. 3A, 3B, and 3C are charts showing data of an air conditioning system of an electric car according to the invention respectively. In FIG. 2A, x-axis represents time, y-axis represents temperature, and a curve represents temperature changes inside an automobile (Tcar). In FIG. 2B, x-axis represents time, y-axis represents power, and a curve represents power changes of the air conditioning system (Pac). In FIG. 2C, x-axis represents time, y-axis represents power, and a connected line represents power changes of the drive system (Pmt). In FIG. 3A, x-axis represents time, y-axis represents temperature, and a curve represents temperature changes inside an automobile (Tcar). In FIG. 3B, x-axis represents time, y-axis represents power, and a curve represents power changes of the air conditioning system (Pac). In FIG. 3C, x-axis represents time, y-axis represents power, and a connected line represents power changes of the drive system (Pmt). Power Pmt of the drive system may change among starting, acceleration, cruising speed, deceleration, idling, and stop. These states can be controlled by a driver when driving.

Referring to FIGS. 2A, 2B and 2C, they are directed to a conventional air conditioning system of an electric car. The air conditioning system is a non-independent air conditioning system. Rotating speed of the compressor varies as the engine speed varies. The air conditioning system is closed because the total power of the automobile is limited when the drive system operates in its maximum power. As such, temperature inside the automobile rises sharply. The compressor may activate or deactivate in response to temperature changes inside the automobile. Thus, temperature inside the automobile changes greatly.

Referring to FIGS. 3A, 3B and 3C, they are directed to an air conditioning system of an electric car according to the invention. In the startup stage of the automobile, the air conditioning system operates in high power so as to quickly decrease temperature inside the automobile. The compressor operates in a low speed so as to smoothly control temperature inside the automobile when cruising. The air conditioning system can operate in a minimum power even when the drive system operates in its maximum power. This has the benefits of supplying sufficient power to the automobile for driving and preventing temperature inside the automobile from rising greatly.

Integrating operating power Pac of the air conditioning system with respect to time intervals (from 0-500 seconds) will get energy consumed in this period of time. The air conditioning system of the electric car according to the invention consumes energy 20.6% less than that of the conventional air conditioning system of the electric car when the same driving conditions and comfort requirements apply. This is because there is no frequent start and stop of the air conditioning system of the invention. The air conditioning system of the invention operates in low speed but high performance during much of the driving time.

While the invention has been described in terms of preferred embodiments, those skilled in the art will recognize that the invention can be practiced with modifications within the spirit and scope of the appended claims.

What is claimed is:

1. An adaptive control method for an air conditioning system of an electric car comprising the steps of:
(1) instructing a vehicle monitoring system (VMS) to check operating parameters of the electric car;
(2) instructing the VMS to send maximum power (PACe) of the air conditioning system to an air conditioning system controller (ASC);
(3) instructing the ASC to check the operating parameters of the electric car in order to determine whether the air conditioning system should be opened or not;
(4) closing the air conditioning system if the determination of step (3) is negative or comparing the PACe of the air conditioning system with threshold power (PACt) of the air conditioning system if the determination of step (3) is positive; and
(5) (a) closing the air conditioning system if PACe<PACt is a result of the comparison of step (4); (b) operating the air conditioning system in conditions set by the PACt if PACe=PACt is the result of the comparison of step (4), or (c) operating the air conditioning system in conditions set by the ASC if PACe>PACt.

2. The adaptive control method of claim 1, wherein in step (1) the operating parameters represent battery connection of an electrical system of the electric car, and/or a charging status of a battery of the electric car, and/or a maximum allowable discharge power (Pa) of the battery, an operating power (Pe) of a drive system of the electric car, and an operating power (Ps) of other systems of the electric car.

3. The adaptive control method of claim 1, wherein in step (2) the PACe is no greater than a subtraction of the Pe of the drive system and the Ps of other systems from the Pa as expressed by PACe≦Pa−Pe−Ps.

4. The adaptive control method of claim 1, wherein sub-step (c) of step (5) comprising at least one of:
(I) In response to changing a stop status to an activation status of the air conditioning system, the air conditioning system operating a predetermined period of time is based on operating conditions corresponding to the PACt;
(II) in response to starting the electric car and requesting turning on the air conditioning system, gradually increasing an input power (PAC) of the air conditioning system until the PAC reaches a maximum operating power (PACh) of the air conditioning system but no greater than the PACe of the air conditioning system;
(III) adjusting the PAC of the air conditioning system in response to a temperature difference (dT) between temperature inside the electric car and a temperature set point; and
(IV) closing the air conditioning system if the dT is less than a set threshold of the temperature difference (dTs).

5. The adaptive control method of claim 4, wherein in step (III) the PAC of the air conditioning system is increased to a value less than the PACe of the air conditioning system when the dT increases, and the PAC of the air conditioning system is decreased when the dT decreases.

6. The adaptive control method of claim 4, wherein in step (III) the adjustment comprises at least one of conditions of:
(1) configuring a compressor of the air conditioning system to have at least three adjustable rotating speeds, and a fan motor of the air conditioning system to have at least two adjustable rotating speeds;
(2) decreasing a rotating speed of the compressor, and decreasing rotating speeds of fan motors of both a condensing coil and an evaporator coil of the air conditioning system if dT<dTs with an operating power of the air conditioning system being not greater than the PACe otherwise the air conditioning system be closed;
(3) operating the compressor in an intermediate speed, and increasing the rotating speeds of the fan motors of both the condensing coil and the evaporator coil if dT>dTs and dT<T1 with the operating power of the air conditioning system being not greater than the PACe otherwise condition (2) be applied; and
(4) increasing the rotating speed of the compressor, and increasing the rotating speeds of the fan motors of both the condensing coil and the evaporator coil if dT>T1 with the operating power of the air conditioning system being not greater than the PACe otherwise condition (3) be applied.

7. The adaptive control method of claim 4, wherein the rotating speed of the compressor is adjusted by using an inverter or a predetermined regulator so as to adjust an output of the compressor, and also an output power of the air conditioning system.

8. The adaptive control method of claim 4, wherein an adjustment of a load adjusts an output of the compressor, and also an output power of the air conditioning system.

9. The adaptive control method of claim 4, wherein conditions corresponding to the PACt of the air conditioning system comprise at least one of conditions of:
(1) opening a variable speed compressor to operate in a minimum rotating speed, or opening a power adjustable compressor to operate in a minimum load;
(2) opening the fan motors of both the condensing coil and the evaporator coil to operate in a minimum speed; and
(3) opening an electronic expansion valve to a maximum openness.
